(19) United States
(12) Patent Application Publication
(10) Pub. No.: US 2020/0346507 A1
(43) Pub. Date: Nov. 5, 2020

(54) VEHICLE AND METHOD FOR CONTROLLING THEREOF

(71) Applicants: Hyundai Motor Company, Seoul (KR); Kia Motors Corporation, Seoul (KR)

(72) Inventors: Kyungho KIM, Seongnam-si (KR); SeongJun CHOI, lncheon (KR); lnyong JUNG, lncheon (KR)

(73) Assignees: Hyundai Motor Company, Seoul (KR); Kia Motors Corporation, Seoul (KR)

(21) Appl. No.: 16/402,594

(22) Filed: May 3, 2019

(51) Int. Cl. B60G 17/015; B60G 17/018; B60G 17/06; B60G 17/017; B60G 17/0165

(52) U.S. Cl. CPC B60G 17/0152; B60G 17/018; B60G 17/06; B60G 17/017; B60G 17/0165; B60G 2800/16; B60G 2400/952; B60G 2400/80; B60G 2500/10; B60G 2600/182; B60G 2800/20; B60G 2400/204

(57) ABSTRACT

A vehicle may include a speed sensor configured to detect a speed of a vehicle; a door operation sensor configured to detect whether a door of the vehicle is opened or closed; an ambient detection sensor configured to detect a diagonal-front or diagonal-rear vehicle approaching the vehicle; and a controller configured to perform the variable control for the damping force of the damper by using at least one of the door operation signal and the ambient detection sensor signal when the controller receives the signal of the vehicle speed from the speed sensor and the vehicle speed is within a predetermined speed.

### BACKGROUND OF THE INVENTION

### Field of the Invention

The present invention relates to a vehicle and a method for controlling thereof.

### Description of Related Art

A suspension is an apparatus which connects an axle and a vehicle body to prevent damage of the vehicle body or baggage and provide ride comfort by preventing vibration or impact, which is applied to the axle from a road to the vehicle body, from being directly transmitted to the axle when a vehicle runs.

An electronic controlled suspension (ECS) of a vehicle may change a damping force (damping coefficient) of a damper according to a road surface and a running situation to maintain steering stability when the vehicle runs and provide better ride comfort than a vehicle in which a mechanical suspension is disposed so that both of running stability and ride comfort may be improved. Here, control of a current supplied to a solenoid valve is important to control the damping force of the damper.

Such an ECS may perform stop control to decrease the damping force of the damper when the vehicle is stopped (for example, a vehicle speed is five kilometers per hour (kph) or less). A stop control function is a function of minimizing movement of a stopped vehicle to improve ride comfort.

For example, movement of the stopped vehicle may occur when passengers enter or exit a vehicle, when a vehicle on a straight lane passes by at a high speed in a state in which a vehicle is temporarily stopped to wait for a left turn signal, when an approaching vehicle passes by at a high speed in a state in which a vehicle is temporarily stopped to wait for a traffic signal or due to a traffic jam, and the like. In the instant case, since a stopped vehicle violently shakes laterally due to a pressure difference of air, a position of the stopped vehicle is unstable so that a driver or passengers may feel anxious. Accordingly, the ECS may improve ride comfort by minimizing movement of the vehicle using the stop control function.

However, a conventional ECS unconditionally considers a vehicle speed to simply perform stop control when the vehicle speed is five kph or less so that unnecessary control is performed. That is, a high frequency noise, such as a beeping sound, is continuously generated when a current is applied to a solenoid valve of a damper to increase a damping force, and energy consumption is increased due to the continuous application of the current while a vehicle is stopped.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a vehicle configured for selectively performing stop control by determining a necessary time point when the vehicle is stopped and a method for controlling thereof.

Additional aspects of the disclosure will be set forth in portion in the description which follows and, in part, will be obvious from the description, or may be learned by practice of the disclosure.

In accordance with one aspect of the present invention, a vehicle configured to perform variable control for a damping force of a damper is provided, the vehicle including a speed sensor configured to detect a speed of a vehicle; a door operation sensor configured to detect whether a door of the vehicle is opened or closed; an ambient detection sensor configured to detect a diagonal-front or diagonal-rear vehicle approaching the vehicle; and a controller configured to perform the variable control for the damping force of the damper by using at least one of the door operation signal and the ambient detection sensor signal when the controller receives the signal of the vehicle speed from the speed sensor and a vehicle speed is within a predetermined speed.

The controller may detect whether a passenger enters or exits the vehicle using the door operation signal and increase the damping force of the damper when the door operation signal is input.

The controller may count an operation time period of the door and change the damping force of the damper.

The controller may be configured to determine a distance to the diagonal-front vehicle using the ambient detection sensor signal, determine whether the diagonal-front vehicle approaches the vehicle at a predetermined speed or greater than the predetermined speed when the distance to the diagonal-front vehicle is within a predetermined distance, and increase the damping force of the damper when the diagonal-front or diagonal-rear vehicle approaches the vehicle at the predetermined speed or greater than the predetermined speed.

The controller may estimate a speed of the diagonal-front vehicle and change the damping force of the damper.

Furthermore, in accordance with another aspect of the present invention, a vehicle configured to perform variable control for a damping force of a damper is provided, the vehicle including a speed sensor configured to detect a speed of the vehicle; a door operation sensor configured to detect whether a door of the vehicle is opened or closed; and a controller configured to receive the signal of the vehicle speed from the speed sensor, determine a stop state of the vehicle when the vehicle speed is within a predetermined speed, receive a door operation signal from the door operation sensor to detect whether a passenger enters or exits the vehicle when the vehicle is stopped, and increase a damping force of a damper when the door operation signal is input.

Furthermore, in accordance with yet another aspect of the present invention, a vehicle configured to perform variable control for a damping force of a damper is provided, the vehicle including a speed sensor configured to detect a speed of the vehicle; an ambient detection sensor configured to detect a diagonal-front or diagonal-rear vehicle approaching the vehicle; and a controller configured to receive the signal of the vehicle speed from the speed sensor, determine a stop state of the vehicle when the vehicle speed is within a predetermined speed, receive an ambient recognition signal from the ambient detection sensor to determine a distance to the diagonal-front or diagonal-rear vehicle when the vehicle is stopped, determine whether the diagonal-front or diagonal-rear vehicle approaches the vehicle at a predetermined speed or greater than the predetermined speed when the distance to the diagonal-front or diagonal-rear vehicle is within a predetermined distance, and perform variable control for a damping force of a damper when the diagonal-front or diagonal-rear vehicle approaches the vehicle at a predetermined speed or greater than the predetermined speed.

Furthermore, in accordance with yet another aspect of the present invention, a method of performing variable control for a damping force of a damper is provided, the method including detecting a vehicle speed to determine whether the vehicle speed is within a predetermined speed; determining whether a door of the vehicle is opened or closed and a door operation signal is input; determining whether a diagonal-front or diagonal-rear vehicle approaches the vehicle using an ambient detection sensor; and performing variable control for a damping force of a damper using at least of the door operation signal and the ambient detection sensor signal when the vehicle speed is within a predetermined speed.

The performing of the variable control of the damping force of the damper may include detecting entry or exit of a passenger into or from the vehicle using the door operation signal and detecting the damping force of the damper when the door operation signal is input.

The performing of the variable control for the damping force of the damper may include determining a distance to the diagonal-front or diagonal-rear vehicle using the ambient detection sensor signal, determining whether the diagonal-front or diagonal-rear vehicle approaches the vehicle at a predetermined speed or greater than the predetermined speed when the distance to the diagonal-front or diagonal-rear vehicle is within a predetermined distance, and increasing the damping force of the damper when the diagonal-front or diagonal-rear vehicle approaches the vehicle at the predetermined speed or greater than the predetermined speed.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view exemplarily illustrating an external of a vehicle according to an exemplary embodiment of the present invention;

FIG. 2 is a view exemplarily illustrating an internal configuration of the vehicle according to an exemplary embodiment of the present invention;

FIG. 3 is a control block diagram of the vehicle according to an exemplary embodiment of the present invention;

FIG. 4 is an example view exemplarily illustrating a state in which the vehicle according to an exemplary embodiment of the present invention performs electronic controlled suspension (ECS) stop control on a road;

FIG. 5 is a graph showing a state in which a current is applied in a section ‘S1’ of FIG. 4;

FIG. 6 is a graph showing a state in which a current is applied in a section ‘S2’ of FIG. 4; and

FIG. 7 is a graph showing a state in which a current is applied in a section ‘S3’ of FIG. 4.

FIG. 8 is a flowchart of an operation of the ECS stop control of the vehicle according to an exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Embodiments described in the exemplary embodiment and configurations illustrated in the drawings are only exemplary examples of the included disclosure, and the disclosure covers various modifications that can substitute for the exemplary embodiments and the accompanying drawings at the time of filing of the present application

Furthermore, the same reference numerals or symbols refer to parts or components that perform substantially the same function.

Furthermore, terms used in the exemplary embodiment are merely used to describe exemplary embodiments and are not intended to limit and/or restrict the embodiments. An expression used in the singular encompasses the expression of the plural unless it has a clearly different meaning in context. In the exemplary embodiment, the terms such as “including,” “having,” and “comprising” are intended to indicate the presence of the features, numbers, steps, actions, components, parts, or combinations thereof included in the specification, and are not intended to preclude the possibility that one or more other features, numbers, steps, actions, components, parts, or combinations thereof may be present or added.

Furthermore, it may be understood that, although the terms “first,” “second,” etc. may be used herein to describe various elements, these elements may not be limited by these terms. These terms are only used to distinguish one element from another. For example, a first element could be termed a second element, and, similarly, a second element could be termed a first element, without departing from the scope of the present invention. As used herein, the term “and/or” may include one or combinations of a plurality of associated listed items.

Hereinafter, embodiments of a vehicle and a method for controlling thereof will be described in detail with reference to the accompanying drawings.

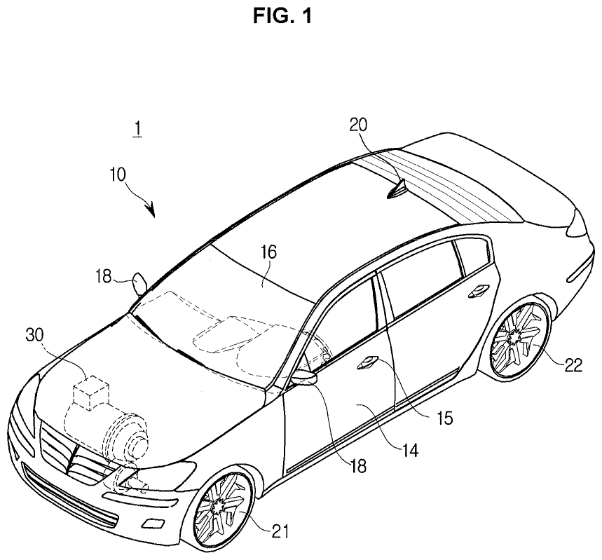

FIG. 1 is a view exemplarily illustrating an external of a vehicle according to an exemplary embodiment of the present invention.

In FIG. 1, a vehicle 1 according to an exemplary embodiment of the present invention may include a vehicle body 10 which forms an external, doors 14 configured to shield an internal formed by the vehicle body 10 from the outside, a front windshield 16 which provides a view in front of the vehicle 1 to a driver, side mirrors 18 which provide a view behind the vehicle 1 to the driver, wheels 21 and 22 configured to move the vehicle 1, and a driving unit 30 configured to rotate the wheels 21 and 22.

The doors 14 may be rotatably mounted on left and right sides of the vehicle body 10 for the driver to enter the vehicle 1 when the door 14 is opened and may shield an internal to the vehicle 1 from the outside. The door 14 may be locked and unlocked using a door handle 15. Locking/releasing of the door handle 15 may be performed by use of a method in which the driver approaches the vehicle 1 and directly manipulates a button or lever of the door handle 15 or a method in which the driver at a position away from the vehicle 1 remotely locks/unlocks the door 14 using a remote control.

The front windshield 16 is provided at an upper side of a front portion of the vehicle body 10 such that the driver obtains forward visual information related to the vehicle 1 and may be formed of windshield glass.

Furthermore, the side mirrors 18 are mounted on the left and right sides of the vehicle body 10 for the driver in the vehicle 1 to obtain visual information beside and behind the vehicle.

Furthermore, the vehicle 1 may include an antenna 20 on an upper surface of the vehicle body 10.

The antenna 20 is an antenna for receiving broadcasting/communication signals and the like of telematics, digital multimedia broadcasting (DMB), a digital television (TV), a global positioning system (GPS), and the like and may be a multifunctional antenna configured to receive various types of broadcasting/communication signals or a single functional antenna configured to receive any one broadcasting/communication signal.

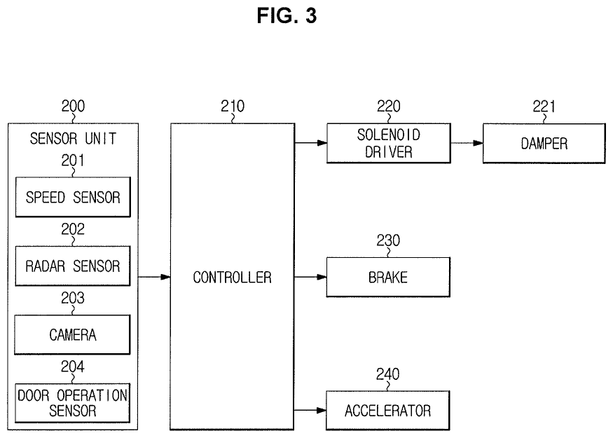

The wheels 21 and 22 include front wheels 21 mounted on the front portion of the vehicle body 10 and rear wheels 22 mounted on a rear portion of the vehicle body 10, and the driving unit 30 provides a rotating force to the front wheels 21 or rear wheels 22 so that the vehicle body 10 moves forward or backward thereof. The driving unit 30 may include an engine 300 (see FIG. 3) configured to burn fossil fuel to generate a rotating force or a motor configured to receive electrical power from a battery 310 (see FIG. 3) to generate a rotating force.

The vehicle 1 according to an exemplary embodiment of the present invention may be an electric vehicle (EV), a hybrid electric vehicle (HEV), or a fuel cell electric vehicle (FCEV).

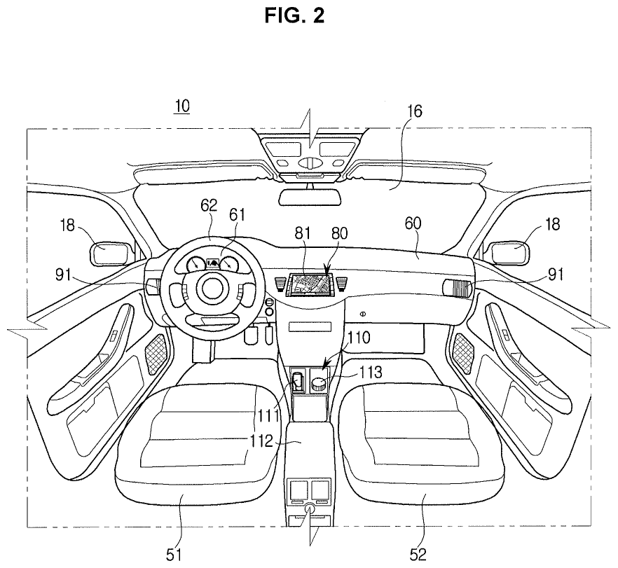

FIG. 2 is a view exemplarily illustrating an internal configuration of the vehicle according to an exemplary embodiment of the present invention.

In FIG. 2, seats 51 and 52 on which passengers sit, a steering wheel 62 provided in front of the driver's seat 51 on which the driver, among the passengers, sits, a cluster 61 provided in front of the steering wheel 62 in a forward direction of the vehicle body 10 and configured to display operation information related to the vehicle 1, and a dashboard 60 which is connected to the cluster 61 and in which various devices for operating the vehicle 1 are disposed may be provided in the vehicle 1.

The dashboard 60 is provided to protrude from a lower end portion of the front windshield 16 toward the seats 51 and 52 such that various devices disposed in the dashboard 60 may be manipulated in a state in which the driver is looking forward from the vehicle 1.

As an example, the various devices provided in a center fascia, which is a center region of the dashboard 60, may include an audio video navigation (AVN) 80, ventilation holes 91 of an air conditioner provided beside a touch screen 81 of the AVN 80, and various input apparatuses provided at a lower end portion of the AVN 80.

The AVN 80 is an apparatus configured for performing audio, video, and navigation functions according to manipulation of the passenger and may be connected to a controller, that is, a head unit configured to control the vehicle 1.

The AVN 80 may also serve two or more functions. For example, turning on audio to play music recorded in a compact disc (CD) or Universal Serial Bus (USB) and the navigation function may be simultaneously performed, or turning on a video to display an image of digital multimedia broadcasting (DMB) and the navigation function may also be simultaneously performed.

The AVN 80 may display an image related to the audio function, an image related to the video function, or an image related to the navigation function through the touch screen 81. The touch screen 81 according to an exemplary embodiment of the present invention may display a charged state of the vehicle 1.

The touch screen 81 may be formed of a liquid crystal display (LCD) panel, a light emitting diode (LED) panel, an organic light emitting diode (OLED) panel, or the like and may perform an image display function and an instruction or command input function.

The touch screen 81 may output an image including a predetermined image to the outside or receive an instruction or command according to an operation system (OS) configured to drive and control the AVN 80 and an application which is being executed in the AVN 80.

The touch screen 81 may display a basic image according to an application which is being executed. The basic image refers to an image displayed by the touch screen 81 when a touch operation is not performed.

The touch screen 81 may also display a touch operation image according to a situation. The touch operation image refers to an image configured for receiving a touch operation from a user.

An input method of the touch screen 81 may be a resistive touch screen method in which a touch operation of a user is detected, a capacitive touch screen method in which a touch operation of a user is detected using a capacitive coupling effect, an optical touch screen method in which infrared rays are used, or an ultrasonic touch screen method in which ultrasonic waves are used. Furthermore, various input methods may be used for the touch screen 81, but the touch screen 81 is not limited thereto.

The touch screen 81 is an apparatus configured for interacting between the AVN 80 provided in the vehicle 1 and the user and is an apparatus configured to receive a user command using a touch interaction and the like and receive a user command using a selected character or menu displayed on the touch screen 81.

Here, the AVN 80 may be referred to as a navigation terminal or display apparatus and may be referred to as one of various names used by those skilled in the art.

Furthermore, since USB ports and the like are disposed in the AVN 80, the AVN 80 may be connected to communication terminals of a smart phone, a portable multimedia player (PMP), an MPEG Audio Layer-3 (MP3) player, a personal digital assistant (PDA), and the like and may also play audio and video files.

In the dashboard 60, the ventilation holes 91 of the air conditioner may be provided at both sides of touch screen 81. The air conditioner refers to an apparatus configured to automatically control an air condition environment including an internal/external environmental condition, circulation, cooling/heating state of air, and the like or to control the air condition environment according to a control command of the user.

For example, the air conditioner may perform both of the heating and cooling and may discharge heated or cooled air through the ventilation holes 91 to control a temperature of the internal to the vehicle 1.

The air conditioner according to an exemplary embodiment of the present invention may operate to adjust a temperature of the internal to the vehicle body 10 before the passengers enter the vehicle 1.

Meanwhile, a center console 110 positioned between the seats 51 and 52 and a tray 112 connected to the center console 110 may be included in the vehicle 1. The center console 110 may include a gear lever 111, various input buttons 113 of a jog shuttle type or key type, and the like, but the center console 110 is not limited thereto.

FIG. 3 is a control block diagram of the vehicle according to an exemplary embodiment of the present invention.

In FIG. 3, the vehicle 1 according to an exemplary embodiment of the present invention may further include a sensor unit 200, a controller 210, a solenoid driver 220, a brake 230, and an accelerator 240 in addition to the components illustrated in FIG. 1 and FIG. 2.

The sensor unit 200 is disposed in the vehicle 1 to monitor a state of the vehicle 1 and may include speed sensors 201, a radar sensor 202, a camera 203, and door operation sensors 204.

The speed sensors 201 are disposed on the front and rear wheels 21 and 22 of the vehicle 1 and may detect speeds of the wheels 21 and 22 while the vehicle 1 runs or a stop state of the vehicle 1 to transmit vehicle speed information to the controller 210.

The radar sensor 202 may emit laser beams in a backward direction of the vehicle 1 to detect obstacles present on a road so that whether obstacles including a following vehicle are present is detected through the laser beams reflected by the obstacles and may measure a time difference in which the emitted laser beams are reflected by the obstacle and return to the vehicle 1 to measure distances to the vehicle.

The camera 203 may be a front extreme wide angle camera configured to capture an image in front of the vehicle 1 and may detect a vehicle which approaches a front side of the vehicle 1.

Furthermore, the camera 203 may be a lane departure warning system (LDWS) camera configured to detect a lane on which the vehicle 1 runs.

The LDWS camera may be disposed at the front side of the vehicle 1, at an internal surface of the front windshield 16 of a lower end portion of a room mirror, and is an LDWS configured to detect a lane of a front road using an image through the camera 203 to determine a lane on which the vehicle 1 currently runs and to provide a warning sound and the like to a driver when a vehicle is about to depart from the road due to carelessness or drowsiness of the driver or the like.

Here, the radar sensor 202 and the camera 203 are ambient detection sensors configured to detect surroundings of the vehicle 1, and the ambient sensor may include a light detection and ranging (lidar) or the like.

As the door operation sensors 204 are sensors configured to detect whether the doors 14 are opened, the door operation sensors 204 may detect whether the doors 14 are opened for passengers to enter or exit the vehicle, whether a trunk is opened to load baggage, and the like.

Furthermore, the sensor unit 200 may also further include various sensors (for example, a steering angle sensor, a yaw rate sensor, and an acceleration sensor) disposed in the vehicle 1.

The steering angle sensor is disposed on a steering column, may detect a steering angle adjusted by the steering wheel 62, and may transmit the steering angle to the controller 210.

The yaw rate sensor may detect a yaw moment generated when the vehicle 1 turns (for example, turns right or left) and transmit the yaw moment to the controller 210. A cerium crystal element is located in the yaw rate sensor, and when the vehicle 1 moves to rotate, the cerium crystal element may rotate and generate a voltage. A yaw rate of the vehicle 1 may be measured on the basis of the generated voltage. As such, the measured yaw rate value may be transmitted to the controller 210.

The acceleration sensor is a sensor configured to measure an acceleration of the vehicle 1 and may include a lateral acceleration sensor and a longitudinal acceleration sensor.

The controller 210 is a processor configured to control overall operations of the vehicle 1 and may be a processor of an electronic control unit (ECU) configured to control overall operations of an electronic controlled suspension (ECS). Furthermore, the controller 210 may control operations of various modules, devices, and the like which are embedded in the vehicle 1. According to an exemplary embodiment of the present invention, the controller 210 generates control signals for controlling the various modules and devices which are embedded in the vehicle 1 to control operations of the components.

Furthermore, the controller 210 may use a controller area network (CAN) of the vehicle 1. The CAN refers to a network system used for transmitting and controlling data between ECUs of the vehicle 1. The CAN transmits data through a two strand data wire which is twisted or shielded by a sheath. The CAN operates according to a multi-master principle in which a plurality of ECUs perform master functions in a master/slave system. Furthermore, in the vehicle 1, the controller 210 may also communicate through a wired network, such as a local interconnect network (LIN) or a media oriented system transport (MOST), in a vehicle or a wireless network such as Bluetooth.

Furthermore, the controller 210 may include a memory in which programs configured to perform the operations which are described above and operations which will be described below and various data related thereto are stored, a hydraulic controller (HCU) which is a unit configured to control a hydraulic pressure, a micro controller unit (MCU), and the like. Furthermore, the controller 210 may be integrated in a system on chip (SOC) embedded in the vehicle 1 and may be operated by a processor. However, since the number of SOCs embedded in the vehicle 1 may not only be one and a plurality of SOCs may also be embedded therein, the controller 210 is not limited to being integrated in only one SOC.

The controller 210 may be realized using a storage medium having at least one type among a flash memory type, a hard disk type, a multimedia card micro type, a memory (for example, a secure digital (SD) or extreme digital (XD) memory) card type, a random access memory (RAM) type, a static random access memory (SRAM) type, a read-only memory (ROM) type, an electrically erasable programmable read-only memory (EEPROM) type, a programmable read-only memory (PROM) type, a magnetic memory type, a magnetic disk type, and an optical disk type. However, the controller 210 is not limited thereto and may also be realized having any different type known to those skilled in the art.

According to an exemplary embodiment of the present invention, the controller 210 may perform stop control of receiving a signal transmitted from the sensor unit 200 to determine a stop state of the vehicle 1 and determining a time point, at which the vehicle 1 moves, to control a damping force of the damper 221 when the vehicle is stopped.

The controller 210 may receive a vehicle speed signal from the speed sensor 201 of the sensor unit 200, and when a vehicle speed is five kilometers per hour (kph) or less, the controller 210 may determine that the vehicle 1 is in a stop state.

In the stop state of the vehicle 1, the controller 210 may perform the stop control only at the time point, at which the vehicle 1 moves, to control a damping force to minimize the movement of the vehicle 1.

To the present end, the controller 210 may perform the stop control of receiving a door operation signal from the door operation sensor 204 of the sensor unit 200 to determine whether passengers enter or exit the vehicle 1 and determine whether baggage is loaded in the trunk when the vehicle 1 is stopped, applying a current to the damper 221 for a predetermined time period to increase a damping force of the damper 221 when receiving the door operation signal so that the movement of the vehicle 1 is minimized, and releasing the application of the current after the predetermined time period. Here, the controller 210 may count a door operation time period to determine a current application duration time during which the current is applied to the damper 221.

Furthermore, the controller 210 may receive an image signal from the camera 203 of the sensor unit 200 to determine whether a running diagonal-front vehicle approaches the vehicle 1. When the running diagonal-front vehicle approaches the vehicle 1 at a predetermined speed or greater than the predetermined speed, the controller 210 may perform the stop control of applying a current to the damper 221 for a current application duration time to increase a damping force of the damper 221 so that movement of the vehicle 1 is minimized and releasing the application of the current after the current application duration time. Here, the controller 210 may estimate a vehicle speed of the diagonal-front vehicle 1 to determine the current application duration time during which the current is applied to the damper 221.

Furthermore, the controller 210 may receive a radar signal from the radar sensor 202 of the sensor unit 200 to determine whether a running diagonal-rear vehicle approaches the vehicle 1. When a running diagonal-rear vehicle approaches the vehicle 1 at a predetermined speed or greater than the predetermined speed, the controller 210 may perform the stop control of applying a current to the damper 221 for a current application duration time to increase a damping force of the damper 221 so that movement of the vehicle 1 is minimized and releasing the application of the current after the current application duration time. Here, the controller 210 may estimate a vehicle speed of the diagonal-rear vehicle to determine the current application duration time during which the current is applied to the damper 221.

As described above, the controller 210 may determine a stop state of the vehicle 1 first using a vehicle speed among signals received from the sensor unit 200. When the vehicle speed is five kph or less, the controller 210 determines that the vehicle 1 is in a stop control condition and may determine a necessary time point to selectively perform the stop control when the vehicle 1 is stopped.

The solenoid driver 220 may control a current applied to the solenoid valve of the damper 221 to minimize movement of the vehicle 1 according to a control signal having a pulse width modulation (PWM) pulse waveform output through the controller 210. That is, the solenoid driver 220 may turn the solenoid valve on or off for a current flow according to a duty of a PWM pulse applied to the damper 221.

The damper 221 is an electrically controlled variable damper and may include the solenoid valve controlled through a PWM control method.

The controller 210 adjusts a duty ratio of a PWM pulse for driving the solenoid valve to control a current applied to the solenoid valve.

The brake 230 may control a hydraulic braking pressure being applied to a wheel cylinder in conjunction with an anti-lock brake system (ABS) control block to maximally secure stability of the vehicle 1 and generate a braking pressure according to a braking signal output from the controller 210.

The accelerator 240 may control an engine torque in conjunction with a traction control system (TCS) control block to maximally secure stability of the vehicle 1 and control a driving force of an engine according to an engine control signal output from the controller 210.

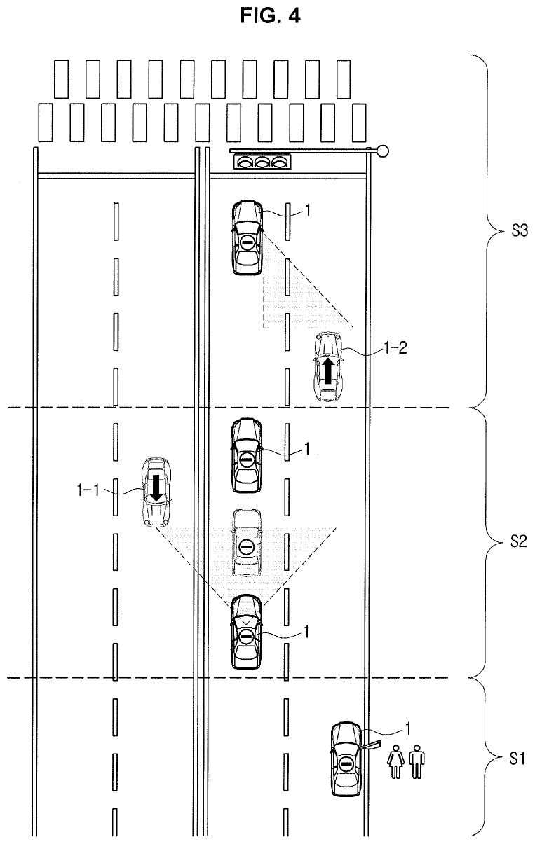

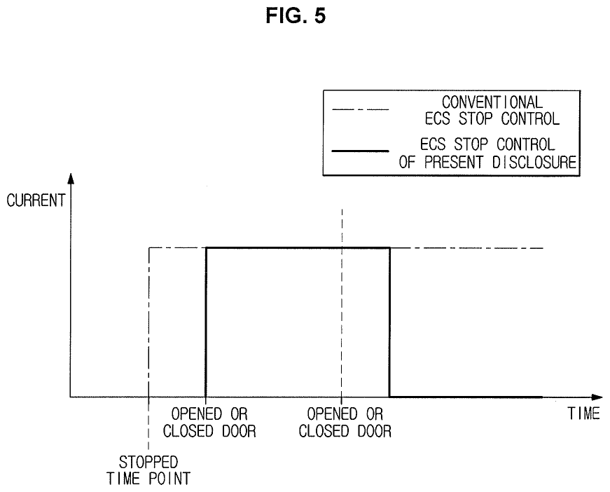

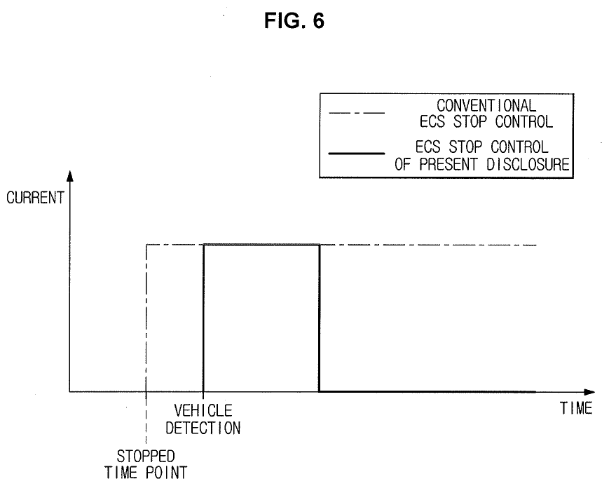

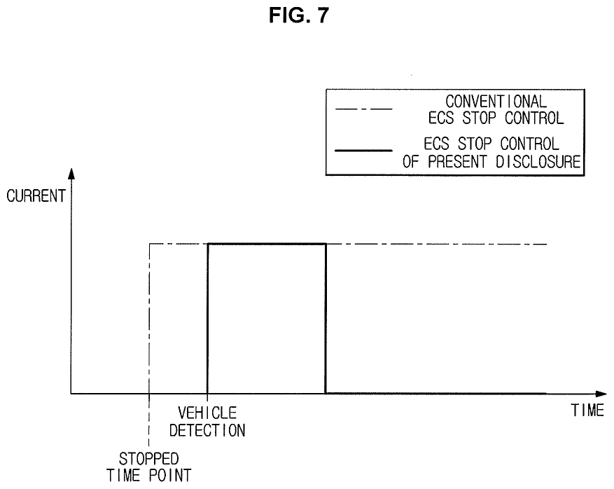

FIG. 4 is an example view exemplarily illustrating a state in which the vehicle according to an exemplary embodiment of the present invention performs ECS stop control on a road, FIG. 5 is a graph showing a state in which a current is applied in a section ‘S1’ of FIG. 4, FIG. 6 is a graph showing a state in which a current is applied in a section ‘S2’ of FIG. 4, and FIG. 7 is a graph showing a state in which a current is applied in a section ‘S3’ of FIG. 4.

In the section ‘S1’ of FIG. 4, a stop control state is illustrated in a case in which the vehicle 1 is stopped and passengers enter or exit the vehicle 1.

When the door 14 of the vehicle 1 is opened or closed for passengers to enter or exit the vehicle, the door operation sensor 204 detects a door operation signal to transmit the door operation signal to the controller 210.

Accordingly, the controller 210 may apply a current to the solenoid valve of the damper 221 for a predetermined time period to increase a damping force of the damper 221 when receiving the door operation signal. When the damping force of the damper 221 is increased, movement of the vehicle 1 may be minimized, and after the predetermined time period, the application of the current is released (see FIG. 5).

As shown in FIG. 5, when conventional ECS stop control is performed, since a current is continuously applied to a damper 221 from a time point at which a vehicle 1 is stopped to a time point at which the stopped situation is released, a high frequency noise, such as a beeping sound, is continuously generated, and energy consumption is increased due to the continuous application of the current when the vehicle 1 is stopped.

However, when the ECS stop control of the present invention is performed, since the application of the current to the damper 221 starts when the vehicle 1 is stopped, the door operation signal is received, and the application of the current is released after the predetermined time period, the high frequency noise and energy consumption may be reduced.

In the section ‘S2’ of FIG. 4, a stop control state is illustrated in a case in which the vehicle 1 is stopped and an opposite vehicle, that is, a diagonal-front vehicle 1-1, runs past the vehicle 1.

When the diagonal-front vehicle 1-1 is detected by the camera 203 and the diagonal-front vehicle 1-1 approaches the vehicle 1 at a predetermined speed or greater than the predetermined speed, the controller 210 may apply a current to the solenoid valve of the damper 221 for a current application duration time to increase a damping force of the damper 221. Here, a vehicle speed of the diagonal-front vehicle 1-1 may be estimated to determine the current application duration time during which the current is supplied the damper 221. When the damping force of the damper 221 is increased, movement of the vehicle 1 may be minimized, and the application of the current is released after the current application duration time (see FIG. 6).

As shown in FIG. 6, when conventional ECS stop control is performed, since a current is continuously applied to a damper 221 from a time point at which a vehicle 1 is stopped to a time point at which the stopped situation is released, a high frequency noise, such as a beeping sound, is continuously generated, and energy consumption is increased due to the continuous application of the current when the vehicle is stopped.

However, when the ECS stop control of the present invention is performed, since the application of the current to the damper 221 starts when the vehicle 1 is stopped, the diagonal-front vehicle 1-1 approaches the vehicle 1 at the predetermined speed or greater than the predetermined speed, and the application of the current is released after the current application duration time, a high frequency noise and energy consumption may be reduced.

In the section ‘S3’ of FIG. 4, a stop control state is illustrated in a case in which the vehicle 1 is stopped and a vehicle, that is, a diagonal-rear vehicle 1-2, runs past the vehicle 1.

When the diagonal-rear vehicle 1-2 is detected by the radar sensor 202 and the diagonal-rear vehicle 1-2 approaches the vehicle 1 at a predetermined speed or greater than the predetermined speed, the controller 210 may apply a current to the solenoid valve of the damper 221 for a current application duration time to increase a damping force of the damper 221. Here, a vehicle speed of the diagonal-rear vehicle 1-2 may be estimated to determine the current application duration time during which the current is applied to the damper 221. When the damping force of the damper 221 is increased, movement of the vehicle 1 may be minimized, and the application of the current is released after the current application duration time (see FIG. 7).

As shown in FIG. 7, when conventional ECS stop control is performed, since a current is continuously applied to a damper 221 from a time point at which a vehicle 1 is stopped to a time point at which the stopped situation is released, a high frequency noise, such as a beeping sound, is continuously generated, and energy consumption is increased due to the continuous application of the current when the vehicle 1 is stopped.

However, when the ECS stop control of the present invention is performed, since the application of the current to the damper 221 starts when the diagonal-rear vehicle 1-2 approaches the vehicle 1 at the predetermined speed or greater than the predetermined speed and the application of the current is released after the current application duration time, a high frequency noise and energy consumption may be reduced.

Hereinafter, an operation process and an operation effect of the vehicle and a method for controlling thereof according to an exemplary embodiment of the present invention will be described.

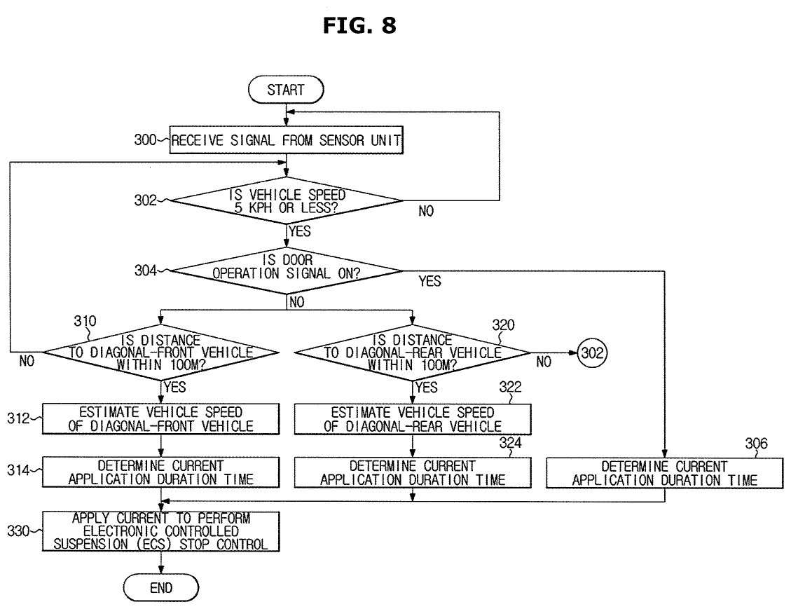

FIG. 8 is a flowchart of an operation of the ECS stop control of the vehicle according to an exemplary embodiment of the present invention, and the ECS stop control is performed in a case in which the vehicle 1 is stopped and starts when the engine of the vehicle 1 is started up.

In FIG. 8, when the vehicle 1 is running on a road, the controller 210 receives CAN signals from the various sensors of the sensor unit 200 disposed in the vehicle 1 (300).

The controller 210 may determine a stop state of the vehicle 1 first through a vehicle speed among the signals received from the sensor unit 200. Accordingly, the controller 210 receives a vehicle speed signal from the speed sensor 201 of the sensor unit 200 and determines whether a vehicle speed is five kph or less (302).

In a determination result of the operation 302, when the vehicle speed is five kph or more, the controller 210 determines that the vehicle 1 has entered a running state, sets a current application duration time for ECS stop control to zero, returns to the operation 300, and performs a next operation.

Meanwhile, in the result of the operation 302, when the vehicle speed is five kph or less, the controller 210 determines that the vehicle is in a stop control condition and performs a next operation to selectively perform ECS stop control at a necessary time point when the vehicle is stopped.

First, the controller 210 monitors a door operation signal through the door operation sensor 204 to determine whether the door operation signal is on (304).

In a determination result of the operation 304, when the door operation signal is on, the controller 210 determines that the door 14 is opened or closed for passengers to enter or exit the vehicle 1 (or to load baggage in a trunk) and determines a current application duration time for applying a current to the damper 221 (306). Here, the current application duration time may be determined as an arbitrary time period to minimize movement of the vehicle 1 when the door 14 is opened or closed for the passengers to enter or exit.

Meanwhile, in the determination result of the operation 304, when the door operation signal is not on, the controller 210 monitors a distance to the diagonal-front vehicle 1-1 using the camera 203 and determines whether the distance to the diagonal-front vehicle 1-1 is within 100 m (310).

In a determination result of the operation 310, the distance to the diagonal-front vehicle 1-1 is within 100 m, the controller 210 estimates a vehicle speed of the diagonal-front vehicle 1-1 to determine whether the diagonal-front vehicle 1-1 approaches the vehicle 1 at a predetermined speed or greater than the predetermined speed (312), and determines a current application duration time for applying a current to the damper 211 (314). Here, the current application duration time may be determined as an arbitrary time period to minimize movement of the vehicle 1 according to the vehicle speed of the diagonal-front vehicle 1-1.

Meanwhile, as the result of the operation 310, when the distance to the diagonal-front vehicle 1-1 is not within 100 m, since the controller 210 does not need to determine whether the diagonal-front vehicle 1-1 approaches the vehicle 1 at the predetermined speed or greater than the predetermined speed, the controller 210 sets the current application duration time for the ECS stop control to zero, returns to the operation 302, and performs a next operation.

Furthermore, in the determination result of the operation 304, when the door operation signal is not on, the controller 210 monitors a distance to the diagonal-rear vehicle 1-2 using the radar sensor 202 and determines whether the distance to the diagonal-rear vehicle 1-2 is within 100 m (320).

In a determination result of the operation 320, when the distance to the diagonal-rear vehicle 1-2 is within 100 m, the controller 210 estimates a vehicle speed of the diagonal-rear vehicle 1-2 to determine whether the diagonal-rear vehicle 1-2 approaches the vehicle 1 at a predetermined speed or greater than the predetermined speed (322) and determines a current application duration time for applying a current to the damper 211 (324). Here, the current application duration time may be determined as an arbitrary time period to minimize movement of the vehicle 1 according to the vehicle speed of the diagonal-rear vehicle 1-2.

Meanwhile, in the determination result of the operation 320, when the distance to the diagonal-rear vehicle 1-2 is not within 100 m, since the controller 210 does not need to determine whether the diagonal-rear vehicle 1-2 approaches the vehicle 1 at the predetermined speed or greater than the predetermined speed, the controller 210 sets the current application duration time for the ECS stop control to zero, returns to the operation 302, and performs a next operation.

As described above, when the vehicle 1 is stopped, since the door operation signal is received, the current application duration time may be determined, the current application duration time may be determined as the diagonal-front vehicle 1-1 approaches the vehicle 1 at the predetermined speed or greater than the predetermined speed, and the current application duration time may be determined while the diagonal-rear vehicle 1-2 approaches the vehicle 1 at the predetermined speed or greater than the predetermined speed.

When the current application duration time is determined, the controller 210 may apply the current to the solenoid valve of the damper 221 through the solenoid driver 220 for the determined current application duration time to increase a damping force of the damper 221. When the damping force of the damper 221 is increased, ECS stop control of minimizing movement of the vehicle 1 may be performed (330).

As is apparent from the above description, according to a vehicle and a method for controlling thereof in various aspects of the present invention, since stop control is performed only when a vehicle moves using ambient detection sensors including a camera, a radar, and the like, and a door operation signal in addition to a vehicle speed, unnecessary noise generation and energy consumption may be reduced to improve commercial value of an ECS system while a conventional stop control function is performed without change. Accordingly, when the ECS vehicle is stopped, since control of a current applied to a damper to increase a damping force is selectively performed at a necessary time point, a high frequency noise generated when the current is applied thereto may be reduced, and energy consumption due to the continuous application of the current may be reduced.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A vehicle of performing variable control for a damping force of a damper, the vehicle comprising:
a speed sensor configured to detect a speed of the vehicle to generate a signal of a vehicle speed;
a door operation sensor configured to detect when a door of the vehicle is opened or closed to generate a door operation signal;
an ambient detection sensor configured to detect a diagonal-front or diagonal-rear vehicle approaching the vehicle to generate an ambient detection sensor signal; and
a controller configured to perform the variable control for the damping force of the damper by using at least one of the door operation signal and the ambient detection sensor signal when the controller receives the signal of the vehicle speed from the speed sensor and the vehicle speed is within a predetermined speed.

2. The vehicle of claim 1,
wherein the controller detects when a passenger enters or exits the vehicle using the door operation signal; and
wherein the controller increases the damping force of the damper when the door operation signal is input.

3. The vehicle of claim 1,
wherein the controller counts an operation time period of the door and changes the damping force of the damper.

4. The vehicle of claim 1,
wherein the controller determines a distance from the vehicle to the diagonal-front vehicle using the ambient detection sensor signal;
wherein the controller determines when the diagonal-front vehicle approaches the vehicle at a predetermined speed or greater than the predetermined speed while the distance from the vehicle to the diagonal-front vehicle is within a predetermined distance; and
wherein the controller increases the damping force of the damper when the diagonal-front or diagonal-rear vehicle approaches the vehicle at the predetermined speed or greater than the predetermined speed.

5. The vehicle of claim 4, wherein the controller increases the damping force of the damper when the diagonal-front or diagonal-rear vehicle approaches the vehicle at the predetermined speed or greater than the predetermined speed.

6. The vehicle of claim 5,
wherein the controller estimates a speed of the diagonal-front vehicle, and changes the damping force of the damper.

7. A vehicle of performing variable control for a damping force of a damper, the vehicle comprising:
a speed sensor configured to detect a vehicle speed of the vehicle and to generate a signal of the vehicle speed;
a door operation sensor configured to detect when a door of the vehicle is opened or closed and to generate a door operation signal when the door of the vehicle is opened or closed; and
a controller configured to receive the signal of the vehicle speed from the speed sensor, to determine a stop state of the vehicle when the vehicle speed is within a predetermined speed, to receive the door operation signal from the door operation sensor to detect when a passenger enters or exits the vehicle when the vehicle is stopped, and to increase the damping force of the damper when the door operation signal is input.

8. The vehicle of claim 7,
wherein the controller counts an operation time period of the door; and changes the damping force of the damper.

9. A vehicle of performing variable control for a damping force of a damper, the vehicle comprising:
a speed sensor configured to detect a vehicle speed of the vehicle and to generate a signal of the vehicle speed;
an ambient detection sensor configured to detect a diagonal-front or diagonal-rear vehicle approaching the vehicle; and
a controller configured to receive the signal of the vehicle speed from the speed sensor, determine a stop state of the vehicle when the vehicle speed is within a predetermined speed, to receive an ambient recognition signal from the ambient detection sensor to determine a distance from the vehicle to the diagonal-front or diagonal-rear vehicle when the vehicle is stopped, to determine when the diagonal-front or diagonal-rear vehicle approaches the vehicle at a predetermined speed or greater than the predetermined speed when the distance from the vehicle to the diagonal-front or diagonal-rear vehicle is within a predetermined distance, and to perform the variable control for the damping force of the damper when the diagonal-front or diagonal-rear vehicle approaches the vehicle at a predetermined speed or greater than the predetermined speed.

10. The vehicle of claim 9,
wherein the controller estimates a speed of the diagonal-front or diagonal-rear vehicle, and changes the damping force of the damper.

11. A method of performing variable control for a damping force of a damper of a vehicle, the method comprising:
detecting a vehicle speed of the vehicle to determine when the vehicle speed is within a predetermined speed;
determining, by a controller, when a door of the vehicle is opened or closed and a door operation signal is input;
determining, by the controller, when a diagonal-front or diagonal-rear vehicle approaches the vehicle using an ambient detection sensor generating an ambient detection sensor signal; and
performing, by the controller, the variable control for the damping force of the damper using at least of the door operation signal and the ambient detection sensor signal when the vehicle speed is within a predetermined speed.

12. The method of claim 11, wherein the performing of the variable control of the damping force of the damper includes:
detecting entry or exit of a passenger into or from the vehicle using the door operation signal; and
increasing the damping force of the damper when the door operation signal is input.

13. The method of claim 11, wherein the performing of the variable control for the damping force of the damper includes:
determining a distance from the vehicle to the diagonal-front or diagonal-rear vehicle using the ambient detection sensor signal;
determining when the diagonal-front or diagonal-rear vehicle approaches the vehicle at a predetermined speed or greater than the predetermined speed while the distance from the vehicle to the diagonal-front or diagonal-rear vehicle is within a predetermined distance; and
increasing the damping force of the damper when the diagonal-front or diagonal-rear vehicle approaches the vehicle at the predetermined speed or greater than the predetermined speed.
